(19) United States
(12) Patent Application Publication
(10) Pub. No.: US 2024/0368928 A1
(43) Pub. Date: Nov. 7, 2024

(54) SLIDING DOOR BLOCKING SYSTEM

(71) Applicant: PrevEntry USA LLC, Pocatello, ID (US)

(72) Inventors: Lewis Spencer, Pocatello, ID (US); Jeff Young, Idaho Falls, ID (US)

(21) Appl. No.: 18/635,196

(22) Filed: Apr. 15, 2024

Related U.S. Application Data
(60) Provisional application No. 63/463,335, filed on May 2, 2023.

(51) Int. Cl. E05C 19/18; E05D 15/06; E06B 5/11

(52) U.S. Cl. CPC E05C 19/188; E06B 5/11

(57) ABSTRACT

A sliding door blocking system includes a first blocking apparatus and a second blocking apparatus. The first blocking apparatus may have a first raised portion and at least two first wings. The second blocking apparatus may have a second raised portion and at least two second wings. The first and second blocking apparatuses may both be placed in tracks of a sliding door frame to prevent a sliding door from being removed. That is, the at least two first wings and the at least two second wings may be inserted into the tracks of the sliding door frame.

### CROSS-REFERENCE TO RELATED APPLICATIONS

This application claims the benefit of U.S. Provisional Application Ser. No. 63/463,335, filed on May 2, 2023, which is incorporated herein by reference.

### TECHNICAL FIELD

The present disclosure relates to a system that prevents sliding doors from being removed. More particularly, the present disclosure relates to a system that fastens to the tracks of the sliding door frame so as to prevent intruders from removing the sliding door and entering.

### BACKGROUND

Crime has increased dramatically since 2020. As an example, just in early 2022, thefts and robberies have increased by 20 percent in major cities throughout the United States. When it comes to these thefts and robberies, intruders often will look for easy entry points into a structure, such as a home or business. Because sliding doors have easier locks to open, offer a large view of the interior of the structure, and can be removed off of their tracks, intruders will usually target these entrances.

To address these issues, many have replaced standard locks on the sliding doors with more robust locks. In addition, others may place a metal or wooden security bar at the base of the sliding door so that the sliding door cannot be opened. A major shortcoming of the security bar is that it adds the extra step of removing and storing the bar prior to opening a sliding door. Because of this, the security bar essentially removes the convenience of having a sliding door. The look and feel of the security bars may also be unappealing, making the structure feel uninviting for non-intruders. It should also be noted that many security bars are awkward to use and do not prevent an intruder from removing a sliding door off its tracks.

Accordingly, there is a need for a convenient to use and aesthetically appealing system that prevents a sliding door from being removed from its tracks. The present invention seeks to solve these and other problems.

### SUMMARY OF EXAMPLE EMBODIMENTS

In one embodiment, a sliding door blocking system comprises a first blocking apparatus and a second blocking apparatus. The first blocking apparatus may comprise a first aperture and a second aperture. The first blocking apparatus may comprise a first upper, raised portion that includes the first and second apertures. The first blocking apparatus may contact an upper surface of a sliding door when the sliding door is lifted. As such, if an intruder attempts to lift the sliding door off of its tracks, the upper surface of the sliding door will contact the first blocking apparatus and prevent removal of the sliding door. The first raised portion may comprise an upper surface. The first raised portion may further comprise a first side that descends from the first raised portion. A first wing may extend outward away from, which is perpendicular to, the first side. The first raised portion may further comprise a second side that descends from the first raised portion. A second wing may extend outward away from, which is perpendicular to, the second side. It will be understood that the first wing and the second wing may each be positioned in upper tracks of the sliding door frame.

The first blocking apparatus may further comprise a first plate, a second plate, and a third plate. The first, second, and third plates may be sized to match the upper surface of the first raised portion. Each of the first, second, and third plates may comprise first plate apertures that can align with the first and second apertures on the first raised portion. The first blocking apparatus may include multiple plates to address sliding door tracks and channels that have different heights. The first, second, and third plates may be coupled to the first raised portion via a first fastener and a second fastener.

The second blocking apparatus, which may be interchangeable with the first blocking apparatus, may comprise a third aperture and a fourth aperture. The second blocking apparatus may comprise a second upper, raised portion that includes the third and fourth apertures. The second blocking apparatus may contact an upper surface of a sliding door when the sliding door is lifted. As such, if an intruder attempts to lift the sliding door off of its tracks, the upper surface of the sliding door will contact the second blocking apparatus and prevent removal of the sliding door. The second raised portion may comprise an upper surface. The second raised portion may further comprise a third side that descends from the second raised portion. A third wing may extend outward away from, which is perpendicular to, the third side. The second raised portion may further comprise a fourth side that descends from the second raised portion. A fourth wing may extend outward away from, which is perpendicular to, the fourth side. It will be understood that the third wing and the fourth wing may each be positioned in upper tracks of the sliding door frame.

The second blocking apparatus may further comprise a fourth plate, a fifth plate, and a sixth plate. The fourth, fifth, and sixth plates may be sized to match the upper surface of the second raised portion. Each of the fourth, fifth, and sixth plates may comprise second plate apertures that can align with the third and fourth apertures on the second raised portion. The second blocking apparatus may include multiple plates to address sliding door tracks and channels that have different heights. The fourth, fifth, and sixth plates may be coupled to the second raised portion via a third fastener and a fourth fastener.

### BRIEF DESCRIPTION OF THE DRAWINGS

FIG. 1 illustrates a top, side perspective view of a first blocking apparatus of a sliding door blocking system;

FIG. 2 illustrates a bottom, front perspective view of a first blocking apparatus of a sliding door blocking system;

FIG. 3 illustrates a side perspective view of a first blocking apparatus and plates of a sliding door blocking system;

FIG. 4 illustrates a top, side perspective view of a second blocking apparatus of a sliding door blocking system;

FIG. 5 illustrates a bottom, front perspective view of a second blocking apparatus of a sliding door blocking system;

FIG. 6 illustrates a side perspective view of a second blocking apparatus and plates of a sliding door blocking system;

FIG. 7 illustrates a top plan view of a first blocking apparatus and a second blocking apparatus of a sliding door blocking system; and

FIG. 8 illustrates a front elevation view of a first blocking apparatus of a sliding door blocking system.

### DETAILED DESCRIPTION OF EXAMPLE EMBODIMENTS

While embodiments of the present disclosure may be subject to various modifications and alternative forms, specific embodiments have been shown by way of example in the drawings and will be described in detail herein. However, the present disclosure is not intended to be limited to the particular features, forms, components, etc. disclosed. Rather, the present disclosure will cover all modifications, equivalents, and alternatives falling within the scope of the present disclosure.

Reference to the invention, the present disclosure, or the like are not intended to restrict or limit the invention, the present disclosure, or the like to exact features or steps of any one or more of the exemplary embodiments disclosed herein. References to “one embodiment,” “an embodiment,” “alternate embodiments,” “some embodiments,” and the like, may indicate that the embodiment(s) so described may include a particular feature, structure, or characteristic, but not every embodiment necessarily includes the particular feature, structure, or characteristic.

Any arrangements herein are meant to be illustrative and do not limit the invention's scope. Although specific terms are employed herein, they are used in a generic and descriptive sense only and not for purposes of limitation. Unless otherwise defined herein, such terms are intended to be given their ordinary meaning not inconsistent with that applicable in the relevant industry and without restriction to any specific embodiment hereinafter described.

It will be understood that the steps of any such processes or methods are not limited to being carried out in any particular sequence, arrangement, or with any particular graphics or interface. In fact, the steps of the disclosed processes or methods generally may be carried out in various, different sequences and arrangements while still being in the scope of the present invention. Certain terms are used herein, such as “comprising” and “including,” and similar terms are meant to be “open” and not “closed” terms.

As previously described, there is a need for a convenient to use and aesthetically appealing system that prevents a sliding door from being removed from its tracks. The present invention seeks to solve these and other problems.

With the rise in crime, individuals have turned to many security systems and accessories to prevent intruders from entering. Intruders will often look for easy access points to enter a structure, which typically leads to sliding glass doors. There are some inherent shortcomings in sliding glass doors, which include a large view of the interior of the structure, usually they are in more private portions of the structure (e.g., the backyard), and the sliding doors may be removed from their tracks to allow easy access to the interior of the structure. Due to these shortcomings, individuals have turned to all sorts of components to prevent entry through sliding doors. Some of these attempts have manifested in security systems that alarm authorities when the sliding door is opened without permission, while others have turned to security bars, which create additional hassle for a user. Furthermore, alarm systems and security bars may not prevent an intruder from removing the sliding door off of its tracks.

The sliding door blocking system described herein is configured to prevent intruders from removing a sliding door off of its tracks. The sliding door blocking system includes a first blocking apparatus and a second blocking apparatus. Both the first and second blocking apparatuses may be positioned in upper tracks of a sliding door frame. The first and second blocking apparatuses may be configured to receive one or more plates so that the height of the first and second blocking apparatuses may be adjustable so as to accommodate numerous types of door designs. It will be appreciated that the sliding door blocking system is easy to install and prevents sliding doors from being removed, thereby protecting individuals and their possessions.

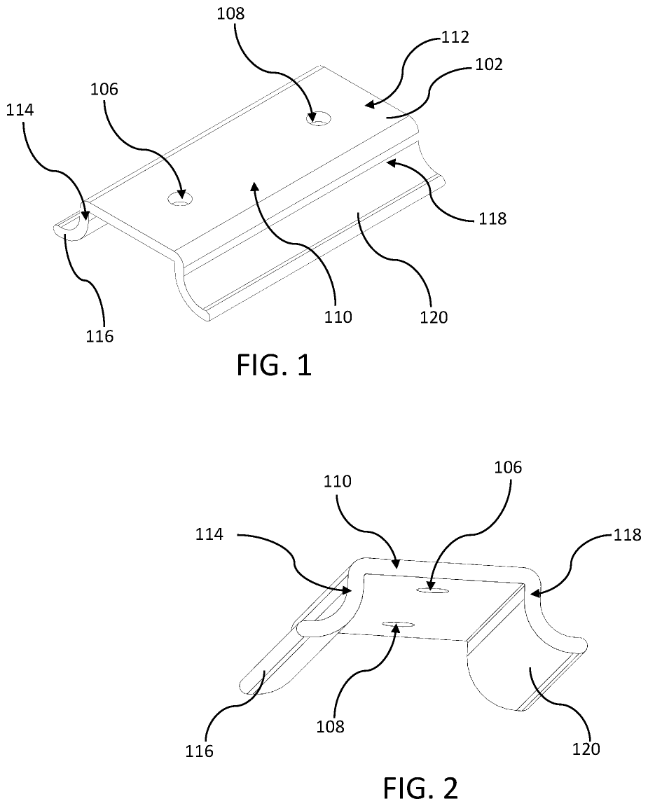

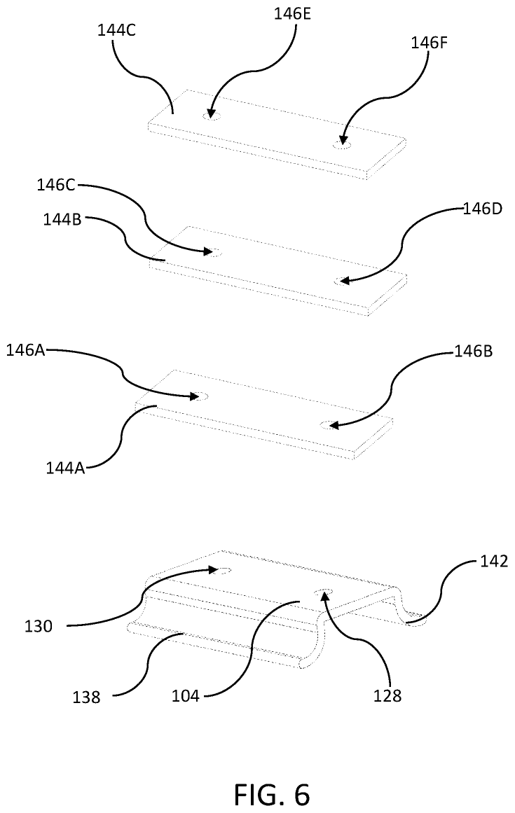

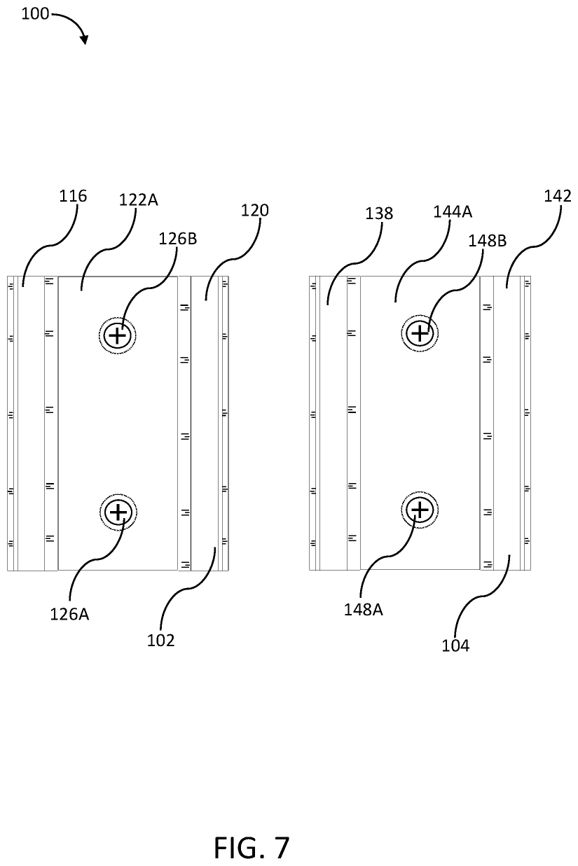

As shown in FIGS. 1-6, in one embodiment, a sliding door blocking system 100 (FIG. 7) comprises a first blocking apparatus 102 and a second blocking apparatus 104.

FIGS. 1-3 illustrate various views of the first blocking apparatus 102. The first blocking apparatus 102 may comprise a first aperture 106 and a second aperture 108. While two apertures are illustrated, it will be appreciated that the first blocking apparatus 102 may have more or less than two apertures. For example, the first blocking apparatus 102 may have a single aperture. The first blocking apparatus 102 may be generally rectangular in shape. The first blocking apparatus 102 may comprise numerous lengths, widths, and heights to fit all sizes of sliding door tracks. Further, the first blocking apparatus 102 may be manufactured from plastic. Other materials may include steel, aluminum, carbon fiber, etc. In some embodiments, the first blocking apparatus 102 may be manufactured from a pliable material that maintains its structure, such as those discussed above. In other embodiments, the first blocking apparatus 102 may comprise a non-pliable material. The first blocking apparatus 102 may comprise a first upper, raised portion 110 that includes the first and second apertures 106, 108. The first blocking apparatus 102 may contact an upper surface of a sliding door when the door is lifted upward. As such, if an intruder attempts to lift the sliding door off of its tracks, the upper surface of the sliding door will contact the first blocking apparatus 102 and prevent removal of the sliding door. The first raised portion 110 may comprise an upper surface 112 that is relatively flat or, in some embodiments, may be curved. The first raised portion 110 may further comprise a first side 114 that descends from the first raised portion 110. A first wing 116 may extend outward away from, which is perpendicular to, the first side 114. The first raised portion 110 may further comprise a second side 118 that descends from the first raised portion 110. A second wing 120 may extend outward away from, which is perpendicular to, the second side 118. It will be understood that the first wing 116 and the second wing 120 may each be positioned in upper tracks of the sliding door frame.

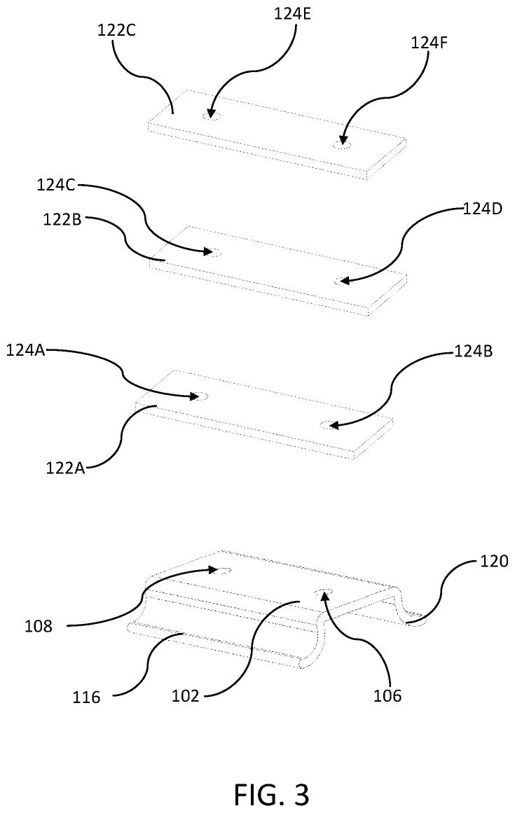

As shown in FIGS. 3 and 7, the first blocking apparatus 102 may further comprise a first plate 122A, a second plate 122B, and a third plate 122C. While three plates 122A, 122B, 122C are shown, the first blocking apparatus 102 may include more or less than three plates; for example, the first blocking apparatus 102 may comprise four plates. In some embodiments, the plates 122A, 122B, 122C may vary in thickness from one to another. In some embodiments, the plates 122A, 122B, 122C may vary in length. The first, second, and third plates 122A, 122B, 122C may be sized to match the upper surface 112 of the first raised portion 110. In some embodiments, the plates 122A, 122B, 122C may vary in thickness from one to another. Each of the first, second, and third plates 122A, 122B, 122C may comprise first plate apertures 124A-124F that can align with the first and second apertures 106, 108 on the first raised portion 110. The first blocking apparatus 102 may include multiple plates to address sliding door tracks and channels that have different heights. As such, if a sliding door has a larger gap between the sliding door frame and the upper surface of the sliding door, then additional plates, such as the first, second, or third plates 122A, 122B, 122C, may be added to the first blocking apparatus 102. The first, second, and third plates 122A, 122B, 122C may be coupled to the first raised portion 110 via a first fastener 126A and a second fastener 126B. The first fastener 126A may comprise a first bolt and a first nut, and the second fastener 126B may comprise a second bolt and a second nut. Other fasteners may include tape, hook and loop, magnets, etc. to couple the plates 122A, 122B, 122C to the first raised portion and to each other. Once the first, second, and/or third plates 122A, 122B, 122C and the first plate apertures 124A-124F are aligned with the first and second apertures 106, 108, a user may place the first fastener 126A and the second fastener 126B through the first plate apertures 124A-124F on the first, second, and/or third plate 122A, 122B, 122C, thereby fastening the first, second, and/or third plates 122A, 122B, 122C to the first raised portion 110.

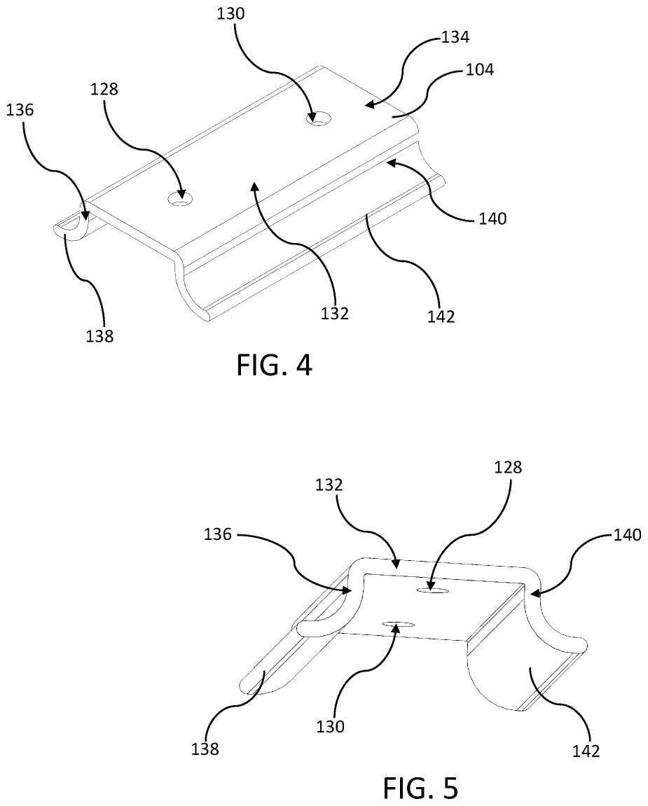

FIGS. 4-7 illustrate various views of the second blocking apparatus 104. The second blocking apparatus 104, which may be interchangeable with the first blocking apparatus 102, may comprise a third aperture 128 and a fourth aperture 130. While two apertures are illustrated, it will be appreciated that the second blocking apparatus 104 may have more or less than two apertures. For example, the second blocking apparatus 104 may have a single aperture. The second blocking apparatus 104 may be generally rectangular in shape. The second blocking apparatus 104 may comprise numerous lengths, widths, and heights to fit all sizes of sliding door tracks. Further, the second blocking apparatus 104 may be manufactured from plastic. Other materials may include steel, aluminum, carbon fiber, etc. In some embodiments, the second blocking apparatus 104 may be manufactured from a pliable material that maintains its structure, such as those discussed above. In other embodiments, the second blocking apparatus 104 may comprise a non-pliable material. The second blocking apparatus 104 may comprise a second upper, raised portion 132 that includes the third and fourth apertures 128, 130. The second blocking apparatus 104 may contact an upper surface of a sliding door. As such, if an intruder attempts to lift the sliding door off of its tracks, the upper surface of the sliding door will contact the second blocking apparatus 104 and prevent removal of the sliding door. The second raised portion 132 may comprise an upper surface 134 that is relatively flat, or in some embodiments, may be curved. The second raised portion 132 may further comprise a third side 136 that descends from the second raised portion 132. A third wing 138 may extend outward away from, which is perpendicular to, the third side 136. The second raised portion 132 may further comprise a fourth side 140 that descends from the second raised portion 132. A fourth wing 142 may extend outward away from, which is perpendicular to, the fourth side 140. It will be understood that the third wing 138 and the fourth wing 142 may each be positioned in upper tracks of the sliding door frame.

The second blocking apparatus 104 may further comprise a fourth plate 144A, a fifth plate 144B, and a sixth plate 144C. While three plates 144A, 144B, 144C are shown, the second blocking apparatus 104 may include more or less than three plates; for example, the second blocking apparatus 104 may comprise four plates. In some embodiments, the plates 144A, 144B, 144C may vary in thickness from one to another. In some embodiments, the plates 144A, 144B, 144C may vary in length. The fourth, fifth, and sixth plates 144A, 144B, 144C may be sized to match the upper surface 134 of the second raised portion 132. In some embodiments, the plates 144A, 144B, 144C may vary in thickness from one to another. Each of the fourth, fifth, and sixth plates 144A, 144B, 144C may comprise second plate apertures 146A-146F that can align with the third and fourth apertures 128, 130 on the second raised portion 132. The second blocking apparatus 104 may include multiple plates to address sliding door tracks and channels that have different heights. As such, if a sliding door has a larger gap between the sliding door frame and the upper surface of the sliding door, then additional plates, such as the fourth, fifth, and sixth plates 144A, 144B, 144C, may be added to the second blocking apparatus 104. The fourth, fifth, and sixth plates 144A, 144B, 144C may be coupled to the second raised portion 132 via a third fastener 148A and a fourth fastener 148B. The third fastener 148A may comprise a first bolt and a first nut, and the fourth fastener 148B may comprise a second bolt and a second nut. Other fasteners may include tape, hook and loop, magnets, etc. to couple the plates to the second raised portion and to each other. Once the fourth, fifth, and/or sixth plates 144A, 144B, 144C and the second plate apertures 146A, 146B, 146C are aligned with the third and fourth apertures 128, 130, a user may place the third fastener 148A and the fourth fastener 148B through the second plate apertures 146A-146F on the fourth, fifth, and/or sixth plates 144A, 144B, 144C, thereby fastening the fourth, fifth, and/or sixth plates 144A, 144B, 144C to the second raised portion 132. It will be appreciated that the first blocking apparatus 102 and the second blocking apparatus 104, as well as the first, second, and third plates 122A, 122B, 122C and the fourth, fifth, and sixth plates 144A, 144B, 144C, may be interchangeable.

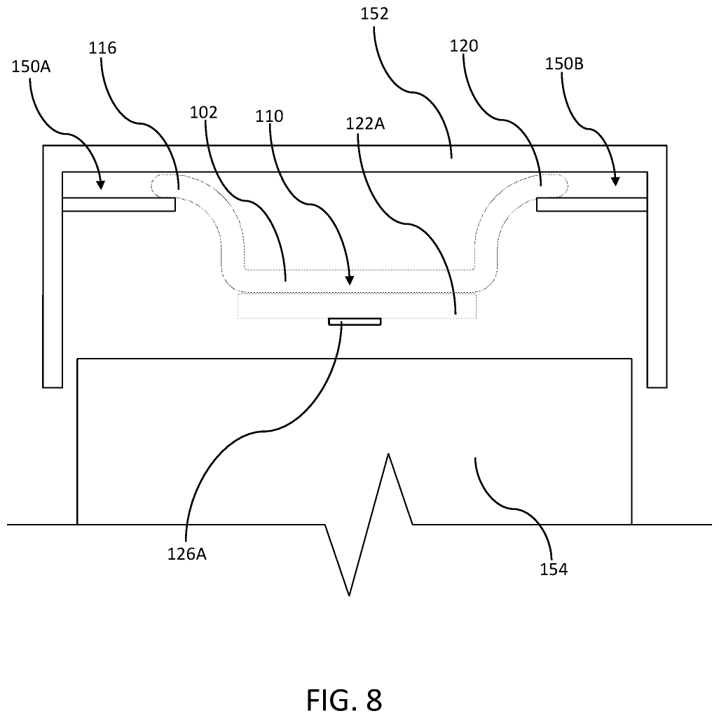

FIG. 8 illustrates the first blocking apparatus 102 coupled to a door frame. To position the first and second wings 116, 120 of the first blocking apparatus 102 and the third and fourth wings 138, 142 of the second blocking apparatus 104 in upper tracks 150A, 150B of a sliding door frame 152, a user may insert the first and second wings 116, 120 and the third and fourth wings 138, 142 into their respective tracks. Once the initial wing, such as the first and third wings 116, 138, is placed in one of the upper tracks 150A, 150B, the user may apply lateral pressure to the first and second sides 114, 118 or the third and fourth sides 136, 140, thereby allowing portions of the blocking apparatuses 102, 104 to bend so that the remaining wing, such as the second and fourth wings 120, 142, may be placed in one of the upper tracks 150A, 150B. In some embodiments, the first and second blocking apparatuses 102, 104 may simply slide into the upper tracks 150A, 150B without bending. The first blocking apparatus 102 may be placed in the upper tracks 150A, 150B at a first end of a sliding door 154 and the second blocking apparatus 104 may be placed in the upper tracks 150A, 150B at a second end of the sliding door 154, or vice versa, so as to prevent the sliding door 154 from being lifted and removed from its tracks. In some embodiments, either the first or second blocking apparatus 102, 104 may be used. In other embodiments, there may be more than the first and the second blocking apparatuses 102, 104 used, such as a first, second, and a third blocking apparatus. It will be appreciated that the blocking system 100 may be positioned and fastened without the need of tools. It will further be appreciated that the blocking system 100 may prevent a sliding door from being lifted up from the outside and out of its tracks by an intruder. In some embodiments, the blocking system 100 may be used with aluminum sliding doors. To use the blocking system 100 with aluminum sliding doors, a user may fasten the blocking system 100 to the aluminum frame via one or more screws, double-sided tape, etc.

It will be understood that while various embodiments have been disclosed herein, other embodiments are contemplated. Further, systems and/or methods according to certain embodiments of the present disclosure may include, incorporate, or otherwise comprise properties or features described in other embodiments. Consequently, various features of certain embodiments can be compatible with, combined with, included in, and/or incorporated into other embodiments of the present disclosure. Therefore, disclosure of certain features or components relative to a specific embodiment of the present disclosure should not be construed as limiting the application or inclusion of said features or components to the specific embodiment unless stated. As such, other embodiments can also include said features, components, members, elements, parts, and/or portions without necessarily departing from the scope of the present disclosure. The embodiments are examples of the present disclosure. Accordingly, unless a feature or component is described as requiring another feature or component in combination therewith, any feature herein may be combined with any other feature of a same or different embodiment disclosed herein. Although only a few of the example embodiments have been described in detail herein, those skilled in the art will appreciate that modifications are possible without materially departing from the present disclosure. Accordingly, all modifications may be included within the scope of this invention.

What is claimed is:

1. A sliding door blocking system comprising:
a first blocking apparatus comprising:
one or more first apertures,
one or more first wings extending from sides of the first blocking apparatus, wherein the one or more first wings are positioned in upper tracks of a sliding door frame;
a second blocking apparatus comprising:
one or more second apertures,
one or more second wings extending from sides of the second blocking apparatus, wherein the one or more second wings are positioned in the upper tracks of the sliding door frame.

2. The sliding door blocking system of claim 1, wherein the first blocking apparatus may comprise a first raised, upper portion.

3. The sliding door blocking system of claim 1, wherein the second blocking apparatus may comprise a second raised, upper portion.

4. The sliding door blocking system of claim 1, wherein the one or more first wings comprise a first wing that extends outward away from a first side and a second wing that extends outward away from a second side.

5. The sliding door blocking system of claim 1, wherein the one or more second wings comprise a third wing that extends outward away from a third side and a fourth wing that extends outward away from a fourth side.

6. The sliding door blocking system of claim 1, further comprising one or more first plates coupleable to the first blocking apparatus to increase height of a first upper portion on the first blocking apparatus.

7. The sliding door blocking system of claim 6, wherein the one or more first plates comprise a first plate, a second plate, and a third plate.

8. The sliding door blocking system of claim 1, further comprising one or more second plates coupleable to the second blocking apparatus to increase height of a second upper portion on the second blocking apparatus.

9. The sliding door blocking system of claim 8, wherein the one or more second plates comprise a fourth plate, a fifth plate, and a sixth plate.

10. The sliding door blocking system of claim 1, further comprising one or more first plates that are sized to match an upper surface of the first blocking apparatus, and one or more second plates that are sized to match an upper surface of the second blocking apparatus.

11. A sliding door blocking system comprising:
a first blocking apparatus comprising:
a first raised portion one or more first apertures,
one or more first wings extending from sides of the first blocking apparatus, wherein the one or more first wings are positioned in upper tracks of a sliding door frame,
one or more first plates removably attachable to the first raised portion;
a second blocking apparatus comprising:
a second raised portion,
one or more second apertures,
one or more second wings extending from sides of the second blocking apparatus, wherein the one or more second wings are positioned in the upper tracks of the sliding door frame,
one or more second plates removably attachable to the second raised portion;
wherein the first blocking apparatus is placed at a first end of the upper tracks and the second blocking apparatus is placed at a second end, opposite the first end, of the upper tracks.

12. The sliding door blocking system of claim 11, wherein the one or more first plates are sized to match the first raised portion of the first blocking apparatus, and the one or more second plates are sized to match the second raised portion of the second blocking apparatus.

13. The sliding door blocking system of claim 11, further comprising a first fastener and a second fastener that couple the one or more first plates to the first raised portion, and a third fastener and a fourth fastener that couple the one or more second plates to the second raised portion.

14. The sliding door blocking system of claim 13, wherein the first and second fasteners are a bolt and nut, adhesive tape, hook and loop, or magnets.

15. The sliding door blocking system of claim 13, wherein the third and fourth fasteners are a bolt and nut, adhesive tape, hook and loop, or magnets.

16. The sliding door blocking system of claim 11, wherein the one or more first plates each comprise one or more first plate apertures, and the one or more second plates each comprise one or more second plate apertures.

17. The sliding door blocking system of claim 16, wherein the one or more first apertures on the first raised portion align with the one or more first plate apertures on the one or more first plates, and the one or more second apertures on the second raised portion align with the one or more second plate apertures on the one or more second plates.

18. A sliding door blocking system comprising:
a first blocking apparatus comprising:
a first upper surface,
one or more first apertures on the first upper surface,
one or more first wings extending from sides of the first blocking apparatus, wherein the one or more first wings are positioned in upper tracks of a sliding door frame,
one or more first plates that are removably attachable to the first upper surface, wherein the one or more first plates are coupleable to the first upper surface via a one or more first fasteners;
a second blocking apparatus comprising:
a second upper surface,
one or more second apertures on the second upper surface,
one or more second wings extending from sides of the second blocking apparatus, wherein the one or more second wings are positioned in the upper tracks of the sliding door frame,
one or more second plates that are removably attachable to the second upper surface, wherein the one or more second plates are coupleable to the second upper surface via a one or more second fasteners.

19. The sliding door blocking system of claim 18, wherein the one or more first fasteners and second fasteners are a bolt and nut, adhesive tape, hook and loop, or magnets.
